(19) United States
(12) Patent Application Publication
(10) Pub. No.: US 2006/0251381 A1
(43) Pub. Date: Nov. 9, 2006

(54) MP-ME recorder

(76) Inventors: James G. Wickstead, Mendham, NJ (US); Richard Kriete, Hazlet, NJ (US); Brian Forbes, Wayne, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/430,070

(22) Filed: May 8, 2006

Related U.S. Application Data
(60) Provisional application No. 60/679,166, filed on May 9, 2005.

(51) Int. Cl. H04N 5/91

(52) U.S. Cl. 386/46

(57) ABSTRACT

Method and apparatus for recording a soundtrack simultaneously with the playback of another soundtrack, which may have been previously recorded, to create either a combined soundtrack or two soundtracks capable of being mixed together to provide a mixing of music and voice, voice and voice and other combinations thereof.

### CROSS REFERENCE TO RELATED APPLICATIONS

This application claims priority from U.S. provisional application No. 60/679,166 filed on May 9, 2005, which is incorporated by reference as if fully set forth.

### FIELD OF INVENTION

The present invention relates to recorders and more particularly to recorders having a capability of recording analog and digitally recorded soundtracks concurrent or non concurrent with and adjacent to an original soundtrack enabling the soundtracks to be played back and manipulated concurrently and further, having the capability of compressing the content in a format such as MP3 before recording and decompressing said format at some later time. This invention can be used for personal entertainment, educational, and/or business audio and other recording needs.

### BACKGROUND

Conventional recording devices may be capable of recording soundtracks, but lack the ability to create multiple recordings at different times which may be played individually or concurrently with another soundtrack, allowing each to be individually altered before and after compression, decompression, or storage. Such storage may occur combined or individually on internal and/or removable media.

### SUMMARY

The present invention provides a portable, self-contained, solid state, multiple soundtrack recording and playback device enabling the user to record an analog or digitally recorded soundtrack and then record a second, different soundtrack concurrently or at a later time, and configured to play back each sound track individually or together and allowing the user to independently alter each sound track, such as by making a volume adjustment, during playback. The sound tracks may be stored individually in altered or unaltered states or stored combined, on internal and/or removable media or exported in an analog or digital format. The invention described herein addresses the need for a portable recording device with multiple inputs capable of recording an analog or pre-recorded digital signal that can be used for personal entertainment, education business or other needs requiring the ability to record music or other audio content from a microphone or other source either simultaneously or at some later time and further being able to play back said recorded content in either the original format or in some altered manner, such as volume, per the users' personal preferences. Such a product with these capabilities in a small, self contained and cost effective package is not currently available and the need for such a device is addressed by the invention articulated in this application.

### BRIEF DESCRIPTION OF THE DRAWING(S)

The following drawings are presented to provide a detailed understanding of the invention, wherein like elements are designated by like numerals, and wherein:

FIG. 1 is a simplified schematic functional block diagram embodying the principles of the present invention; and

FIGS. 2 and 3 are schematic function block diagrams of other embodiments of the present invention.

### DETAILED DESCRIPTION OF THE INVENTION

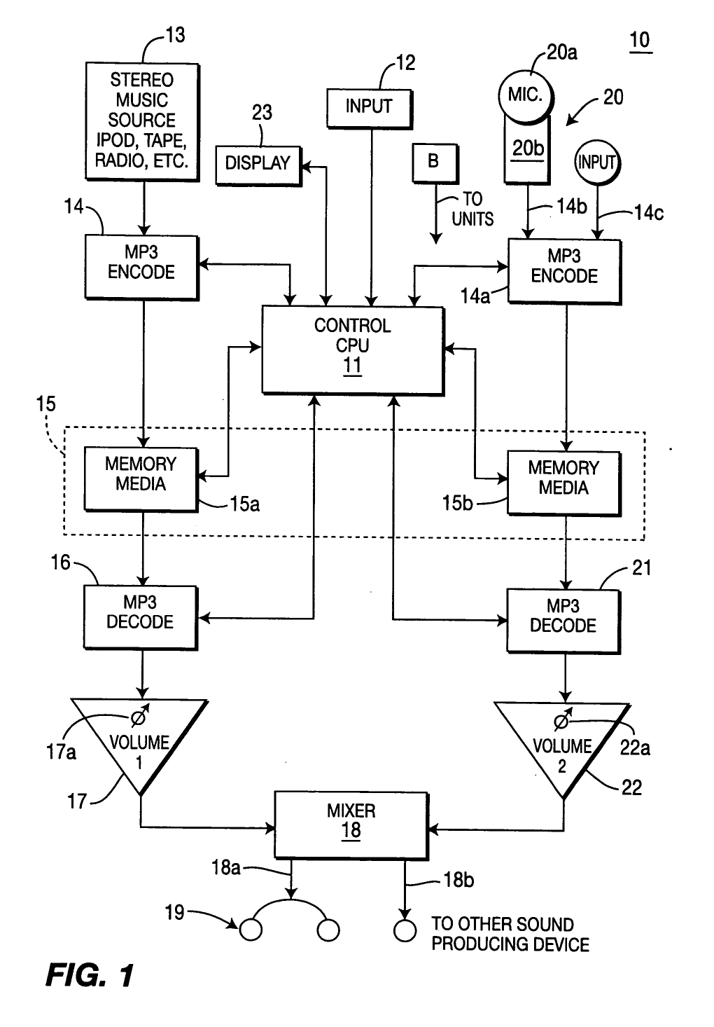

FIG. 1 shows a functional block diagram of an MP-ME device 10 embodying the principles of the present invention and being comprised of a central controller 11, such as, for example, a CPU, having an input 12 which may, for example, be a plurality of a push button operated switches or a keyboard for exerting control of the controller 11 to perform the functions of the MP-ME. As one example, CPU 11 may be controlled to record an original soundtrack. In this operating mode, at input 13, which may be a stereo music source, an iPod, a tape, a radio or other musical source capable of providing an analog signal is coupled to a first MP3 encoder 14 which converts the analog signal into digital form and compresses the signal, as is conventional. The encoded (i.e., compressed) signal is placed in a memory media 15, also under control of CPU 11. Alternatively, the source may be an audio device or output converted into an electrical signal by a microphone coupled to input 13. The device 10 is powered by a portable battery B which provides power to all of the components of device 10. Device 10 is compact, i.e. is a hand-held device whose longest dimension is preferably no greater than 7.0 inches.

If desired, the recorded, compressed soundtrack may be played back by entering the appropriate controls to CPU 11 through input 12, whereby the compressed, recorded signal in track 15a of media 15 is decoded, i.e., is decompressed and converted back into analog form at decoder 16. The recorded soundtrack may be coupled to a set of headphones 19 through a volume control amplifier 17 and a mixer 18. Volume controlled amplifier 17 is capable of controlling the volume of the output signal and is provided with a control knob 17a for adjusting amplitude.

Alternatively, the original track may be played through speakers or any other sound producing device by coupling such sound producing device to the output 18b.

MP-ME 10 is further provided with a second MP3 encoder 14a for encoding a second soundtrack. The source of the second soundtrack may be a device 20 which may include a microphone 20a and suitable amplification means 20b for coupling the sound to be recorded to input 14b of MP3 encoder 14a. Alternatively, any other sound source providing a signal to be recorded may be coupled to the input 14c of MP3 encoder 14a.

The second track to be recorded is converted into digital form and compressed at 14a and stored in memory track 15a of media 15, which is preferably the same memory media which is provided with separate, independent input means for recording the second track.

The track recorded at the media location 15b may be played back under control of CPU 11 by reading the track from memory position 15b to MP3 decoder 21 to decompress the second track, convert it to analog form and apply the signal to mixer 18 through a second amplifier 22, which, similar to amplifier 17 has an adjustable volume which is set by control 22a. The second track may be played by through headphones 19 or any other sound producing device coupled to 18b of mixer 18.

MP-ME 10 may be used in many different ways, some examples of which include, but are not limited to the following:

A concert may be recorded on any suitable portable device which is extremely advantageous for recording a live concert. Alternatively, the concert may have been previously recorded on any suitable recording medium such as a CD, tape or even digital memory device. This recording, in the form of an analog signal, is coupled to MP3 encoder 14 which operates in the manner described above, and which is controlled by CPU 11 by manipulation of the appropriate control keys at input 12 to decompress and record the signal in a digital format.

Assuming that the user desires to provide commentary or sing along with the music recorded in the first soundtrack, the user manipulates the input controls at input 12 to cause CPU 11 to place MP3 decoder 16 into playback mode enabling the user to listen to the original soundtrack, for example, through headphones set 19. The user listens to the soundtrack, and provides commentary by speaking into or singing into microphone 20a, which voice and/or commentary is encoded and compressed at 14a, and stored in media location 15b, under control CPU 11. The sound recorded in tracks 15a and 15b may then be played back simultaneously by appropriate operation of input controls 12, causing CPU 11 to control the decoders 16 and 21 to decompress the signals in their respective soundtracks, and convert them into analog form for playback into headphone set 19, for example. The volumes of the playback signals may be adjusted by the user.

The original soundtrack recorded at 15a in memory medium 15 may be the soundtrack of a live lecture or concert or even a recorded lecture or concert. The user plays back the soundtrack recorded at 15a under control of CPU 11, and, while listening to the soundtrack through headphone set 19, for example, further operates CPU 11 to initiate an operating mode for recording verbal notes or comments contemporaneously with a portion or portions of the soundtrack related to said comments. This is accomplished by making comments through microphone 20a to create a soundtrack at 15b. The user may then review both soundtracks by playing them simultaneously through control of CPU 11, which causes the soundtracks to be decoded and decompressed at 16 and 21, and introduced into the headphone set 19, for example, by the amplifiers 17 and 22 and mixer 18. The user may further choose to edit the commentary by taking note of a display 23 operated by CPU 11, and which is capable of displaying a soundtrack position to enable the user to return to the desired location for editing the commentary. This enables the editing to take place after the user has completely reviewed both soundtracks stored at 15a and 15b.

The source material at 15a may, for example, be a concert or a musical recording. The user may utilize MP-ME 10 as a “rap” machine enabling the user to add words or just plain commentary to the soundtrack 15b. Along somewhat similar lines, the MP-ME maybe utilized as a portable karaoke machine enabling the user to sing or play along with the music recorded in the original soundtrack. The user, through manipulation of the input controls 12, controls CPU 11 to allow the soundtrack being recorded at 15b to be simultaneously played back together with the original soundtrack recorded at 15a. The mixer output 18b may be coupled to a suitable speaker enabling all the people that are gathering to enjoy the karaoke activity, while at the same time providing recordings of the karaoke activity for subsequent replay as well as the instantaneous replay.

The soundtracks recorded at 15a and 15b may comprise musical song tracks which can be played back simultaneously with their recording, enabling the user to encode the MP-ME 10 as a creative sound mixer. In addition, two pieces of the same music recorded by different artists may be easily and readily compared at the same time that they are simultaneously being recorded, or during later playback.

A user may share notes with a friend and receive feedback from the friend. For example, the first user may record notes and send them to a friend. It should be noted that the memory media 15 is preferably removable and may be any suitable storage medium such as a compact flash memory, a memory stick or any other suitable small, portable, digital storage device. Such memory devices may either be hand carried, sent or otherwise mailed to a friend or be transmitted to a friend through the internet since such memory devices are capable of being downloaded to a PC or laptop, for example, and electronically transmitted to the friend. The friend, upon receipt of the recorded “notes” and by employment of an MP-ME 10, adds his or her own concurrent notes which then may be shared with the first user by providing the removable memory medium to the original user either electronically by the Internet or by forwarding the memory medium to the original user.

The MP-ME 10 is further capable of recording and playback of only a single track or recording and playback of multiple tracks individually and independently of one another, with or without consideration of synchronism of the tracks. In another operating mode, the controller 11 is operated to activate the microphone 20a, and couple the output of the microphone amplifier 20b through I/O unit 31 to encoder 14, enabling recording in a common or second track by the user as the user listens to the first recorded track through headphones 19.

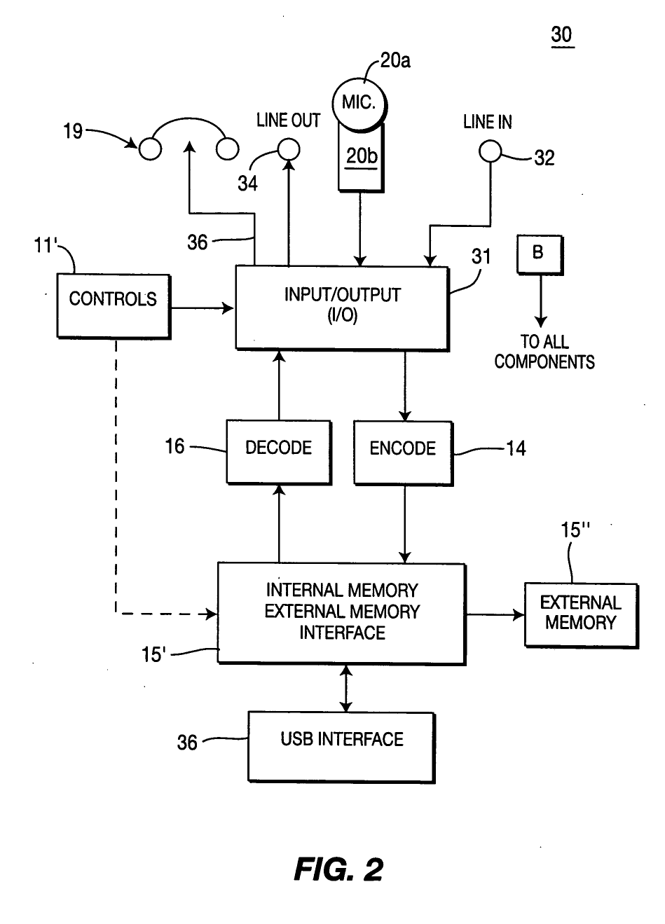

FIG. 2 shows another embodiment 30 of the present invention which is a more simplified embodiment than the embodiment 10 shown in FIG. 1, which, however, is still a battery powered, small, compact unit containing a built-in microphone 20a, phone jacks 32 and 34 for input and output, and controls 11′ which include the manual input controls as well as the controller for the embodiment 30.

An input/output unit 31 receives voice or other acoustic sounds at microphone 20a which are amplified at 20b and applied to I/O unit 31. Analog signals in the form of previously recorded signals are applied to I/O unit 31 by input 32. The analog electrical signals are mixed, at unit 31, encoded and compressed at 14, and stored in an appropriate track in internal memory 15′ under the control of controller 11′. Alternatively, the initial recording may be derived from a audio source converted by microphone 20a into analog electrical signals. Memory 15′ is provided with an external memory interface for transfer of recorded, compressed signals to a removable external memory 15″. The recorded track (or tracks) may also be transferred to a PC or laptop through USB interface 36. Memory device 15′ includes a removable (external) memory medium. In addition, memory 15′ is coupled to a USB interface 36 for deriving digitized, compressed data from a remote source such as a laptop, PC, or the like.

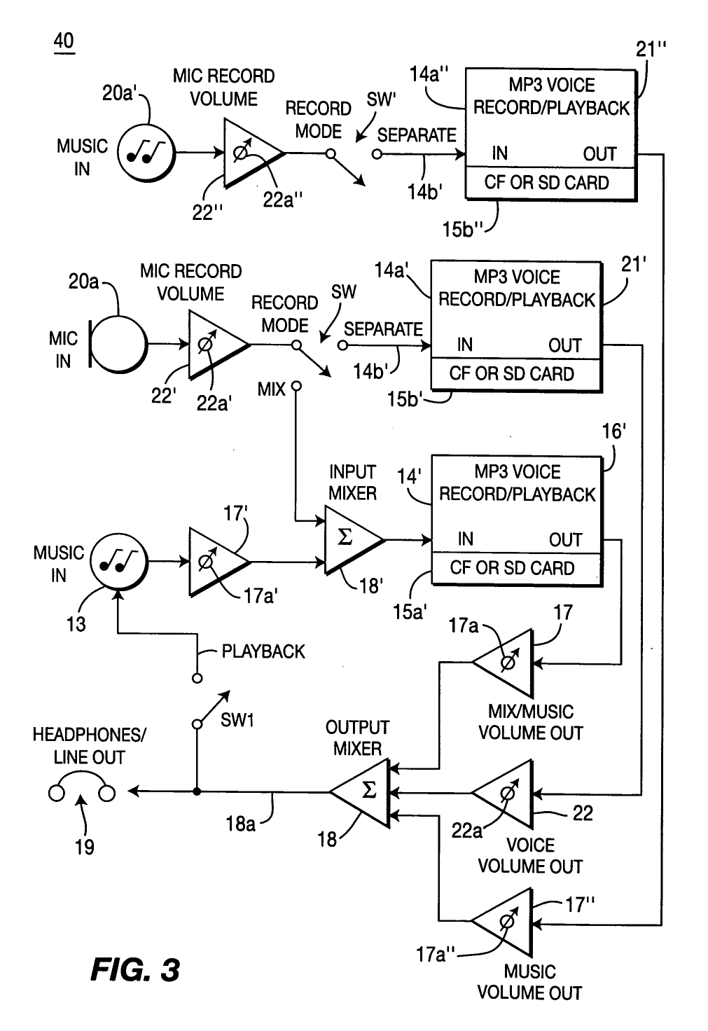

The recorded signal, which is recorded in either one track or two tracks for monaural or stereo performance respectively, in substantially the same manner as described hereinabove with regard to embodiment 10, may be played back under control of controller 11′ through decoder 16, which reverts the compressed digitized signal into an analog signal coupled to output line 36, enabling the user to listen to the recorded track through headphones 19, for example. This particular version plays back the combination of the audio content from input 32 and microphone content from input 20. The relative volumes of the inputs (such as voice and music, for example) can be independently adjusted at the time of recording by adjustable amplifiers 20b in FIGS. 1 and 17′, 22′ and 22″, shown in FIG. 3. An amplifier may be provided between source 13 and encoder 14 of FIG. 1, if desired.

In another embodiment, Unit 40, shown in FIG. 3, two (2) MP3 devices may be employed to record signals in independent memories in a Separate mode and to combine the signals in a Mix mode. Referring to FIG. 3, music at 13 and voice at 20a are amplitude adjusted at 17′ and 22′ and then encoded at 14′ and 14a′ when switch SW is in the Separate mode and combined in input mixer 18′ with SW in the Mix mode and encoded by MP3 encoder 14′. SW is shown in simplified schematic fashion in FIG. 3 for simplicity, it being understood that SW is preferably a controller, such as CPU 11 shown in FIG. 1 The independently encoded signals are stored in separate memories 15a′, 15b′ whereas the mixed signals are recorded in memory 15a′. The memories may be any suitable compact memory device, such as a compact flash (CF) a secure digital (SD) card or any other memory similar in design and function. The SD card is a certification mark of the SD Association. The independently recorded signals may be played back individually or mixed at 18 (and volume adjusted at 17, 22, if desired). The mixed signals which are recorded at 15a′ can also be decoded and played back through mixer 18 and listened to by headphones 19, for example.

In still another embodiment, the source, shown as music at input terminal 13, may be initially encoded and recorded with SW in the Separate mode, and then played back at a later time when a source, such as voice, is provided at terminal 20a. The pre-recorded music is decoded and coupled to terminal 13 with SW1 in Playback mode and SW in the Separate mode. SW1 is shown in simplified schematic form for simplicity, it being understood that this coupling operation is part of the controller (i.e., such as CPU 11).

In still another embodiment, a third MP3 unit is provided. When SW and SW′ are in the Separate mode, music and voice are independently encoded at 14a′ and 14a″ and recorded at 15b′ and 15b″ (it should be understood that SW, shown in simplified schematic fashion, is likewise part of the controller, as described above). With SW in the Mix mode, mixed voice and music are encoded at 14′ and recorded at 15a′. This embodiment enables music and voice to be decoded and played back independently or played back in mixed form. Decoders 21″, 21′ and 16′ are coupled to adjustable amplifiers 17”, 22 and 17. Mixer 18 outputs signals to a headphones 19, for example.

Unit 30 has a variety of uses including:

A karaoke machine that allows the user to record and sing along with his/her favorite music, which music may originate from any source. The final recording may also be played back through the unit 30 or shared with other devices compatible with the removable memory medium 15′.

As further applications of use Unit 30, shown in FIG. 2, may be employed as a “rap” music recorder enabling the user to add words or just plain commentary alongside of any recorded soundtrack.

The Unit 30 may be employed as a voiceover recorder enabling the user to put verbal notes and comments alongside a recording of lectures or a concert.

As a further option, unit 30 can save the recorded music or information to a removable media storage device which can be downloaded or shared with other users having either another unit such as unit 30 or a unit compatible therewith.

The user may record material from any analog sound source such as MP3 recorders/players, iPods, CD players, radios, television, or live events or recordings of live events. The combined soundtrack is stored at 15′ and can be played back through device 30 or electronically shared with other similar products by means of a built-in USB output.

The soundtracks in units 10, 30 and 40 may be independently erased or recorded over without effecting other soundtracks.

What is claimed is:

1. Record/playback apparatus, comprising:
a plurality of inputs each for receiving an analog signal;
at least one encoder for encoding the signals into a digital format;
means for recording the encoded signals into given locations in a recording medium; and
at least one decoder for converting the recorded signals into analog signals.

2. The apparatus of claim 1 further comprising:
a mixer for mixing analog signals.

3. The apparatus of claim 1 further comprising:
means for converting the analog signals into sound.

4. The apparatus of claim 1 wherein said encoder further includes means for compressing the signals prior to recording in said medium.

5. The apparatus of claim 1 wherein said decoder further comprises a means for decompressing said digital signals.

6. The apparatus of claim 2 further comprising an amplifier for amplifying the decoded signals prior to application to said mixer.

7. The apparatus of claim 4 wherein said amplifier is adjustable and is provided with a manually operable adjustment control.

8. The apparatus of claim 2 wherein said mixer is provided with a plurality of outputs for coupling to sound producing devices.

9. The apparatus of claim 8 wherein one of said sound producing devices is a headphone set.

10. The apparatus of claim 8 wherein one of said sound producing devices is a speaker for converting analog signals into sound.

11. The apparatus of claim 1 further comprising a central controller for controlling operations of the encoder, memory media and decoder.

12. The apparatus of claim 11 wherein said controller is a central processing unit (CPU).

13. The apparatus of claim 12 further comprising input means for manually inputting control signals for controlling operation of said CPU.

14. The apparatus of claim 1 wherein a microphone is selectively coupled to said encoder.

15. The apparatus of claim 1 wherein said encoder is provided with a plurality of inputs for selectively coupling analog signals thereto.

16. The apparatus of claim 12 further comprising display means operated by said CPU for displaying operating conditions of said apparatus.

17. The apparatus of claim 16 wherein said CPU controls said display means to display a position at which an analog signal is located during playback of said analog signal in said digital format.

18. The apparatus of claim 1 wherein said memory medium is removably inserted into said apparatus.

19. The apparatus of claim 16 wherein said memory medium is one of a compact flash memory, memory stick, microcassette, secure digital (SD) card or other like compact, removable memory.

20. The apparatus of claim 8, comprising a compact hand-held device which is operated by a small, portable battery.

21. The apparatus of claim 2, comprising:
first and decoders having outputs coupled to said mixer.

22. The apparatus of claim 21, comprising:
first and second encoders.

23. The apparatus of claim 6, comprising:
first and second amplifiers for amplifying analog signals applied to said mixer.

24. The apparatus of claim 23 wherein said amplifiers are adjustable.

25. The apparatus of claim 1 wherein one or both of soundtracks may be independently and selectively erased or recorded over.

26. Record/playback apparatus, comprising:
a plurality of terminals each configured for receiving an analog signal;
a mixer for combining signals at said terminals;
at least one encoder for encoding the combined signals into a digital format;
a memory for recording the encoded signals into given locations in a recording medium; and
at least one decoder for converting the recorded signals into analog signals.

27. The apparatus of claim 26 further comprising:
adjustable amplifiers each coupled between one of said inputs and said mixer.

28. Record/playback apparatus, comprising:
first and second terminals each configured for receiving an analog signal;
first and second encoders for encoding analog signals into a digital format;
a mixer for combining signals applied to first and second mixer inputs and having an output coupled to said first encoder;
first and second memories for recording signals respectively encoded by said first and second encoders;
a controller for respectively coupling said first and second terminals to said first and second mixer inputs in a first operating mode and for respectively coupling only said second terminal to said second mixer input and said first terminal to said first encoder in a second operating mode;
first and second decoders for respectively converting the recorded signals in said first and second memories into analog signals.

29. The apparatus of claim 28 further comprising:
adjustable amplifiers each amplifying signals applied to each terminal.

30. The apparatus of claim 28 further comprising:
a second mixer for mixing signals from said first and second decoders.

31. Record/playback apparatus, comprising:
first and second terminals each configured for receiving an analog signal;
first and second encoders for encoding analog signals into a digital format;
adjustable amplifiers each independently amplifying signals applied to each terminal;
first and second memories for independently recording signals respectively encoded by said first and second encoders; and
first and second decoders for respectively converting the recorded signals in said first and second memories into analog signals.

32. The apparatus of claim 31 further comprising:
a mixer for mixing signals from said first and second decoders.

33. The apparatus of claim 32 further comprising:
means for converting output signals from said mixer into sound.

34. The apparatus of claim 33 further comprising:
means for converting output signals from said mixer into sound.

35. Record/playback apparatus, comprising:
first and second terminals each configured for receiving an analog signal;
first and second encoders for encoding analog signals into a digital format;
adjustable amplifiers each independently amplifying signals applied to each terminal;
first and second memories for independently recording signals respectively encoded by said first and second encoders; and
first and second decoders for respectively converting the recorded signals in said first and second memories into analog signals;
means coupled to one of said first and second decoders to enable playback of said stored signals from its associated memory while employing a remaining one of said first and second encoders and its associated memory to encode and record signals from another signal source coupled to another one of said terminals.

36. The apparatus of claim 35 wherein said means to enable playback further comprises:
means for converting output signals from said one of said first and second decoders into a form suitable for re-recording.

37. Record/playback apparatus, comprising:
first, second and third terminals each configured for receiving an analog signal;
first, second and third encoders for encoding analog signals into a digital format;
adjustable amplifiers each independently amplifying signals applied to each terminal;
first, second and third memories for independently recording signals respectively encoded by said first, second and third encoders;
an input mixer having an output coupled to said third encoder;
first, second and third decoders for respectively converting the recorded signals in said first and second memories into analog signals; and
a controller for respectively coupling said first and second terminals to said first and second encoders in a first mode to provide independent recordings of signals applied to said first and second terminals and for coupling one of said first and second terminals and said third terminal to said input mixer in a second mode to provide a recording of the mixed signals.

38. The apparatus of claim 37 further comprising: adjustable amplifiers each amplifying signals applied to each terminal.
